(19) United States
(12) Patent Application Publication
(10) Pub. No.: US 2007/0080240 A1
(43) Pub. Date: Apr. 12, 2007

(54) Apparatus and method for providing a treatment agent to a flow of water

(76) Inventor: Alfred Schuetz, Zollikofen (CH)

Correspondence Address: CROWELL & MORING LLP;INTELLECTUAL PROPERTY GROUP, P.O. BOX 14300, WASHINGTON, DC, 20044-4300, US

(21) Appl. No.: 10/573,366

(22) PCT Filed: Jul. 27, 2004
(86) PCT No.: PCT/EP04/08378

§ 371 Date: Dec. 12, 2006

(30) Foreign Application Priority Data
Sep. 24, 2003 (DE) 103 44 488.2
Sep. 30, 2003 (DE) 103 45854.9
Sep. 30, 2003 (DE) 103 45 853.0

(51) Int. Cl. B05B 7/26

(52) U.S. Cl. 239/310; 239/583

(57) ABSTRACT

In order to enable treatment agents such as mouth water or abrasive substances to be added to the spray water in an oral douche, the hand piece of the oral douche is provided with a mixing reservoir that includes a mixing chamber on the lower end of the hand piece. The mixing chamber is arranged in the main or subsidiary flow of the spray water supply line. A water-soluble tablet containing the treating agents is arranged therein. Mixing of the treating agents is determined by the shape and size of the supply and discharge line to the mixing chamber.

The invention relates to an oral douche with a conduit leading from a water container to a spray nozzle and an additional reservoir for the supply of a treating agent to the spray nozzle.

One has the option in such oral douches to spray mouth water instead of tap water, for example after the actual cleaning of the teeth, by connecting the conduit by way of a valve with the additional reservoir instead of with the water container. However, it is often desired to spray with the oral douche both water and a treating agent at the same time. The treating agent can be, for example, mouth water or abrasive agents through which the tooth cleaning is intensified.

The invention is based on the problem of developing an oral douche which provides this option of simultaneously supplying water and treating agent to the spray nozzle.

This problem is achieved in an oral douche in accordance with the invention in that the oral douche includes means for the continuous admixture of the treating agent to the water flowing to the spray nozzle.

By admixing the treating agent to the water flowing to the spray nozzle, one achieves that the desired additional agents are already applied to the teeth or into the mouth during use of the oral douche for the cleaning of the teeth.

The reservoir is preferably constructed as a mixing reservoir and positioned between the water container and the spray nozzle, so that the water conveyed to the spray nozzle is passed through the mixing reservoir. A substrate is contained therein which consists of water soluble material. The substrate can be, for example, a solid substrate in the form of a tablet or also a semi-solid substrate in the form of a gel, a paste, or the like. During operation of the oral douche, the water thereby flows past the dissolving substrate, whereby the dissolving particles enter into the mixing reservoir.

A pump which conveys the water to the spray nozzle is generally positioned in or at the water container. Since the admixture of the treating agent in the supply conduit from the pump to the spray nozzle is preferably carried out in the region of a hand piece—which means the mixing system is positioned downstream of the pump—the chemically aggressive and/or abrasive treating agent cannot enter the pump and damage it.

Several possibilities exist for metering of the added amount. For example, the mixing reservoir can be in communication with the main conduit by way of a branch conduit. The water thereby flows from the main conduit through the branch conduit into the mixing reservoir, dissolves the solid substrate therein and flows back out along the same path. As soon as the mixing reservoir is filled, a negative pressure is generated in the main conduit because of the water flowing therein, which causes the water enriched with the treating agent to be sucked from the mixing reservoir. The branch conduit can include a restriction in its diameter for the control of this process, the hydraulic resistance of which determines the return flow.

One achieves a higher water throughput through the mixing reservoir when a parallel conduit is provided in parallel to the branch conduit so that the mixing reservoir is located in a secondary stream to the main conduit. A portion of the water stream which flows through the main conduit is thereby continuously branched off into the secondary stream, mixed with the treating agent and subsequently returned through the parallel conduit into the main stream. The rate of throughput can be controlled by a corresponding restriction in the diameter of the parallel conduit.

Alternatively, the mixing reservoir can also be located in a portion of the main conduit, whereby it is part of the main stream flowing through the main conduit. All water flowing from the water container to the spray nozzle thereby initially flows through the mixing reservoir and is in this manner enriched with the treating agent.

The mixing reservoir preferably includes a central tubular body which forms the supply conduit to the mixing reservoir. The tubular body can thereby also serve as a carrier or holder for a substrate of annular shape. Furthermore, a good admixture of the water with the treating agent is achieved by the increased outflow from the mixing reservoir.

In order to achieve an even flushing of the mixing reservoir, it can be further provided that it is constructed as an annular chamber and includes a turbulence body through which the water is swirled around the solid substrate before it is returned into the main conduit.

The invention further relates to a hand piece for an oral douche with an elongated grip body at the forward end of which is located a spray nozzle and which includes a tube connector, whereby a longitudinal channel forming a main conduit extends in the grip body between the tube connector and the spray nozzle.

The invention is based on the object to form, in a suitable manner, a mixing reservoir in such a hand piece, which allows the continuous admixture of a treating agent to the water flowing to the spray nozzle.

For the solution of this problem, the invention provides that a mixing reservoir forming a mixing chamber be formed in the grip body.

Alternative to the location of the mixing reservoir in the hand piece, it can of course also be housed in a separate housing which among other things also includes a pump for the conveying of the tap water to the spray nozzle and serves as a supporting station for the hand piece when at rest.

The mixing reservoir according to the invention is thereby part of the hand piece and can be constructed integrally therewith. Inserts, for example in the supply tube are thereby not required. Furthermore, the manufacturing cost is low, since only the injection mold for the manufacture of the hand piece need be adapted.

The longitudinal channel preferably extends under the floor of the mixing chamber, whereby a connection with the longitudinal channel is formed through at least one bore in the floor of the mixing chamber, which forms the branch conduit. This bore or cutout in the floor can also be achieved through a corresponding adaptation of the injection mold tool. Furthermore, a short path between the longitudinal channel and the mixing chamber is achieved in this manner so that especially when the mixing chamber is located in the secondary stream, a sufficiently large portion of the amount of water conveyed enters the mixing chamber.

Preferably, the mixing chamber is closed by a removable cap. This allows a simple exchange of a substrate for the treating agent. A turbulence body which swirls the liquid entering the mixing chamber ensures a sufficiently strong dissolution of the substrate.

The mixing chamber includes a central tubular body which has two functions. On the one hand, it serves to support a solid substrate in the form of a tablet, for example of annular shape, on the other hand the bore forming the branch conduit between the longitudinal channel and the mixing chamber extends through the tubular body, whereby a good flow through the mixing chamber is realized, since the bore discharges into the mixing chamber above the tablet placed onto the tubular body.

When furthermore an additional bore forming the parallel conduit connecting the mixing chamber with the longitudinal channel is provided in the floor of the mixing chamber, a flow through the mixing chamber from top to bottom is achieved.

In order to achieve that the mixing chamber is located in the main water flow, the longitudinal channel is closed by a blockage located between the ends of the bores. This can also be achieved by a corresponding construction of the injection molding tool. The mixing chamber and the tube connector are preferably located at the rear end of the grip portion. The water which enters the longitudinal channel of the grip portion through the tube can thereby be immediately guided into the mixing chamber, which has the advantage that an even mixing is achieved along the further path of the water to the spray nozzle, as far as the mixing does not already occur in the mixing chamber.

In order to achieve a simple construction of the hand piece, the mixing chamber and the tube connector are formed on an end piece of the hand piece, whereby the end piece is pushed onto a tubular, central section of the grip portion.

A pipe forming a portion of the main conduit is located in the central section of the grip portion. The pipe can be inserted into a receiving bore in the end piece which is connected with the longitudinal channel. By pushing the end piece onto the grip portion one achieves at the same time a connection between the longitudinal channel and the pipe.

The tube connector is located on the end piece lateral to the longitudinal channel. This results in a redirecting of the water flow and a certain deceleration, which aids the penetration of the water into the mixing chamber.

An exemplary embodiment with several alternate embodiments is illustrated in the following Figures in order to illustrate the idea of the invention. It shows:

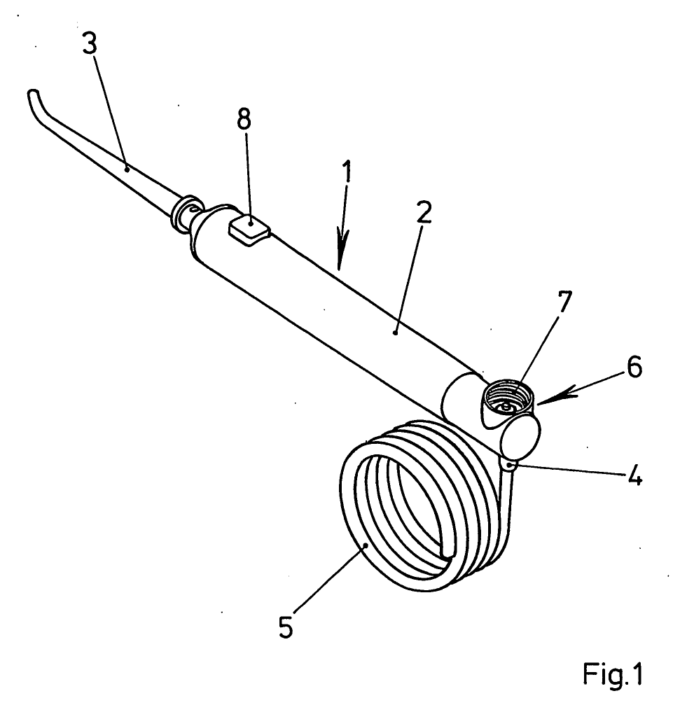

FIG. 1—a perspective illustration of the hand piece of an oral douche,

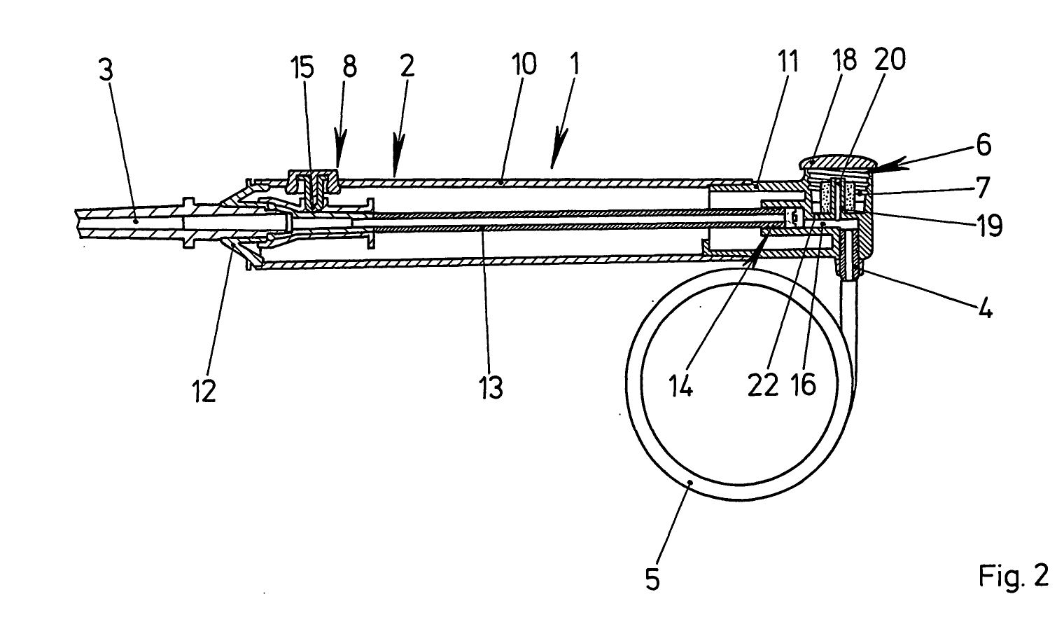

FIG. 2—a longitudinal section through this hand piece and,

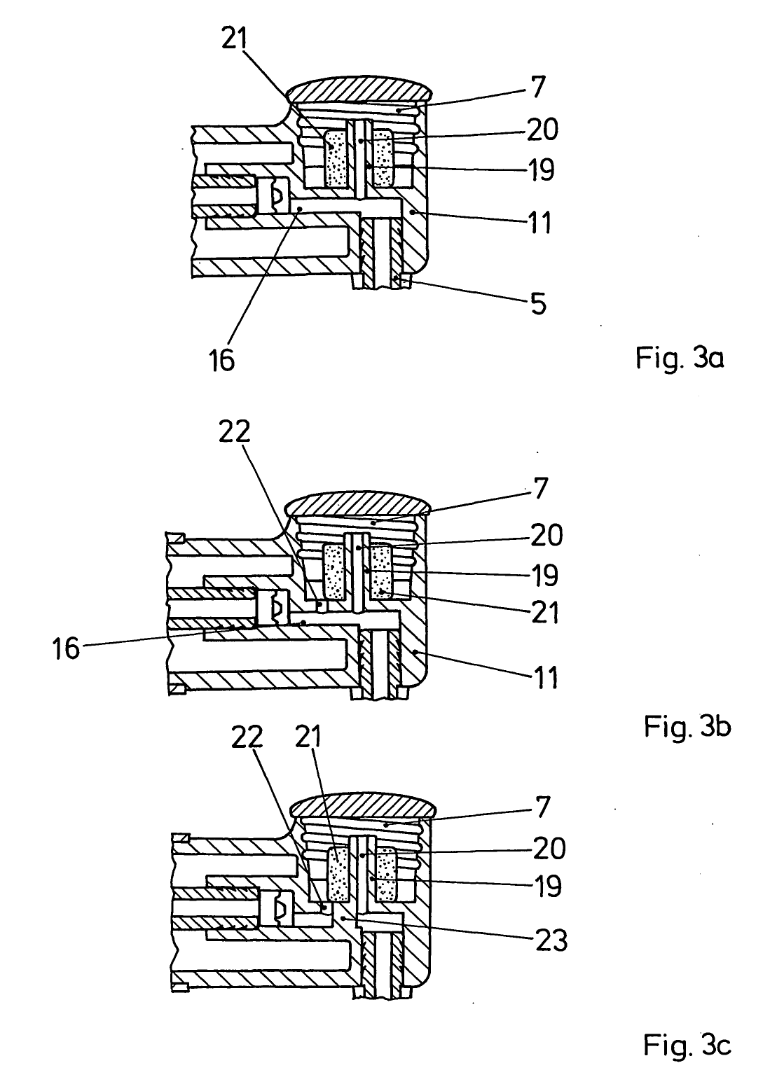

FIGS. 3a-3c—different realizations of the control of the water flow in the region of the mixing reservoir.

Reference is first made to FIG. 1. It shows the typical construction of an oral douche (1). A spray nozzle (3) is pushed onto the forward end of a hand piece (2). A tube connector (4) is located at its rearward end to which a tube (5) is attached. The latter is connected to a further not illustrated pump which again is connected to a here not illustrated water container. A longitudinal channel here not yet apparent extends within the hand piece (2) which connects the tube connector (4) with the spray nozzle (3).

A mixing reservoir (6) is further provided which is formed by a mixing chamber (7) (here illustrated in the open condition) at the rearward end of the hand piece (2).

An actuator key (8) is located at the forward end of the hand piece (2), through the operation of which the longitudinal channel can be closed or opened depending on the construction.

As is apparent from FIG. 2, the hand piece (2) includes a central, pipe-shaped portion (10) into which rearward end an end piece (11) can be inserted. At the forward end of the hand piece, the pipe-shaped portion (10) is closed by cap (12) into which the spray nozzle (3) is inserted.

A pipe (13) extends through the central, pipe-shaped portion (10) which at its rearward end is inserted into a receiving bore (14) in the end piece (11). The forward end which is constructed to be elastically deformable is connected with the spray nozzle (3). The actuator key (8) includes a push button (15) with which the elastically deformable end of the pipe (13) is compressed upon depressing of the actuator key (8) in order to block the pipe cross section so that water can no longer reach the spray nozzle (3).

The tube connector (4) for the tube (5) is located laterally under the end piece (11). The tube connector (4) opens into a longitudinal channel (16) which again ends into the base of the receiving bore (14). The mixing chamber (7) of pot-shaped construction which is closed by a cover (18) is located above the longitudinal channel (16) opposite the tube connector (4). The cover (18) can be screwed or snapped into the mixing chamber (7). A central tubular body (19) is located in the mixing chamber, the longitudinal bore (20) of which opens into the longitudinal channel (16).

The end piece (11) described above is an injection molded part. During assembly of the oral douche (1), it is inserted into the rearward end of the central, pipe-shaped portion (10). The pipe (13) is simultaneously pushed into the receiving bore (14) so that a fluid connection between the tube (5) and the fluid nozzle (3) is created.

The detailed functioning of the mixing reservoir (6) is illustrated in the following FIGS. 3a to 3c.

FIG. 3a shows a first embodiment. The mixing chamber (7) is simply connected through the longitudinal bore (20) and the central tubular body (19) with the longitudinal channel (16) in the end piece (11). An annular tablet (21) is located on the central tubular body (19), which is formed as a solid substrate for the treating agent to be admixed.

As soon as the pump is switched on, water flows through the tube (5) into the longitudinal channel (16) and from there through the longitudinal bore (20) serving as supply conduit into the mixing chamber (7). As soon as the latter is filled, the substrate carrier is partially dissolved so that treating agent enters the water. The water flowing through the longitudinal channel (16), which forms the main flow, generates a negative pressure which again evacuates the water from the mixing chamber through the longitudinal bore (20) now functioning as drainage conduit. As soon as the mixing chamber is at least partially emptied, fresh water flows in again.

Since the longitudinal bore functions both as supply and drainage conduit, only a slight mixing is achieved, so that the ejected water contains only little treating agent. The rate of mixing can be adjusted through the cross section of the longitudinal bore (20). An improved rate of mixing is achieved, when as shown in FIG. 3b an outlet bore (22) is provided as drainage in the floor of the mixing chamber (7). In the direction of flow through the longitudinal channel, this outlet bore is located behind the supply conduit formed by the longitudinal bore (20). The mixing chamber is thereby located in a branch flow to the longitudinal channel (16). The desired rate of mixing is achieved by correspondingly sizing the cross sections of the supply and drainage conduits. An especially large rate of mixing is achieved when especially the supply conduit is only minimally restricted.

The rate of mixing can be even further increased when the longitudinal channel (16)—as shown in FIG. 3c—is interrupted by a blockage (23) so that all of the water flowing through the tube (5) into the end piece is guided into the mixing chamber (7) and from there through the outlet bore (22) back into the longitudinal channel (16). The mixing chamber (7) is thereby located in the main water stream.

In closing, it can be stated that the supply need not necessarily take place through the central tubular body (19). It can be omitted so that annular tablets can also not be used as the substrate carrier. In that embodiment, the supply and discharge conduits consist of simple bores in the floor of the mixing chamber.

### Parts List

1. Oral douche
2. Hand piece
3. Spray nozzle
4. Tube connector
5. Tube
6. Mixing reservoir
7. Mixing chamber
8. Actuator key
9.
10. Pipe-shaped portion
11. End piece
12. Cap
13. Pipe
14. Receiving bore
15. Push button
16. Longitudinal channel
17.
18. Cover
19. Central, tubular body
20. Longitudinal bore
21. Tablet
22. Outlet bore
23. Blockage

1-19. (canceled)

20. An oral douche with a main conduit leading from a water container to a spray nozzle and a reservoir for supply of a treating agent to the spray nozzle, wherein the oral douche includes means for a continuous mixing of the treating agent to water flowing to the spray nozzle.

21. The oral douche according to claim 20, wherein the means includes a reservoir constructed as a mixing reservoir and located between the water container and the spray nozzle, the water flowing to the spray nozzle being guided through the mixing reservoir and wherein a substrate made of a substance soluble by water flowing past is positioned in the mixing reservoir.

22. The oral douche according to claim 21, wherein the mixing reservoir is connected to the main conduit through a branch conduit.

23. The oral douche according to claim 22, wherein the branch conduit includes a restriction in a diameter of the branch conduit.

24. The oral douche according to claim 22, wherein a parallel conduit to the branch conduit is provided so that the mixing reservoir is located in a branch stream relative to the main conduit.

25. The oral douche according to claim 21, wherein the mixing reservoir is located in a portion of the main conduit and thereby is part of a main stream flowing through the main conduit.

26. The oral douche according to claim 22, wherein the mixing reservoir includes a central tubular body which forms the branch conduit.

27. The oral douche according to claim 21, wherein the mixing reservoir is an annular chamber and includes a turbulence body through which the water is swirled around the substrate before it is guided to the spray nozzle.

28. A hand piece for an oral douche with a longitudinal grip body at a forward end of which a spray nozzle is located and which includes a tube connector, wherein between the tube connector and the spray nozzle a longitudinal channel forming a main conduit extends in the grip body, and wherein a mixing chamber forming a mixing reservoir is formed in the grip body.

29. The hand piece according to claim 28, wherein the longitudinal channel extends under a floor of the mixing chamber, wherein a connection exists with the longitudinal channel through at least one bore in the floor of the mixing chamber.

30. The hand piece according to claim 28, wherein the mixing chamber is closed by a removable cap.

31. The hand piece according to claim 30, wherein webs which extend radially and in an arc are formed on an underside of the cap to form a turbulence body.

32. The hand piece according to claim 29, wherein the mixing chamber includes a central tubular body which is adapted for receiving an annular tablet, wherein the bore between the longitudinal channel and the mixing chamber extends along a longitudinal axis of the tubular body.

33. The hand piece according to claim 29, wherein a further bore connecting the mixing chamber with the longitudinal channel is provided in the floor of the mixing chamber.

34. The hand piece according to claim 33, wherein the longitudinal channel includes a blockage between openings of the bores.

35. The hand piece according to claim 28, wherein the mixing chamber and the tube connector are formed at a rearward end of the grip body.

36. The hand piece according to claim 35, wherein the mixing chamber and the tube connector are formed at an end piece of the hand piece, wherein the end piece is pushed onto a central, tubular portion of the grip body.

37. The hand piece according to claim 36, wherein a pipe forming a section of the longitudinal channel is located in the central, tubular portion and is insertable into an insertion bore in the end piece.

38. The hand piece according to claim 36, wherein the tube connector is provided laterally on the end piece.

39. An apparatus for providing a treatment agent to a flow of water, comprising:
a hand piece;
a spray nozzle attached to a front end of the hand piece;
a water supply tube connected to a rear end of the hand piece; and
a mixing reservoir connected to the rear end of the hand piece;
wherein a flow of water is provided to the spray nozzle through the hand piece by the water supply tube and wherein the treatment agent is provided to the flow of water by the mixing reservoir.

40. A method for providing a treatment agent to a flow of water, comprising the steps of:
supplying a flow of water to a spray nozzle attached to a front end of a hand piece by a water supply tube connected to a rear end of the hand piece; and
providing a treatment agent to the flow of water by a mixing reservoir connected to the rear end of the hand piece.
